(19) United States
(12) Patent Application Publication
(10) Pub. No.: US 2007/0133430 A1
(43) Pub. Date: Jun. 14, 2007

(54) Periodic media reservation method for QoS data having periodic transmission characteristic in wireless local area network

(76) Inventors: Dae Ho Kim, Daejeon (KR); Ki Jong Koo, Daejeon (KR); Do Young Kim, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/633,181

(22) Filed: Dec. 4, 2006

(30) Foreign Application Priority Data
Dec. 8, 2005 (KR) 10-2005-0119978

(51) Int. Cl. H04J 1/16

(52) U.S. Cl. 370/252; 370/464; 370/395.21

(57) ABSTRACT

Provided is a method for reducing a transmission delay on the basis of non-contention without performing backoff and polling when transmitting an audio frame of a radio frequency (RF) link section in a voice-over Internet protocol (VoIP) system having a wireless local area network (WLAN) function. The method includes the steps of: (a) obtaining audio information through at least one WLAN terminal; (b) performing one of setting, change and removal of a reservation number (RN) through an RN setting process between the WLAN terminal and an access point (AP); (c) transmitting an audio QoS frame including reservation information obtained by step (b) at every interval when an audio frame is generated in a radio frequency (RF) link section; and (d) setting up a reservation time on the basis of the reservation information included in the received audio QoS frame.

### CROSS-REFERENCE TO RELATED APPLICATION

This application claims priority to and the benefit of Korean Patent Application No. 2005-119978, filed Dec. 8, 2005, the disclosure of which is incorporated herein by reference in its entirety.

### BACKGROUND

1. Field of the Invention

The present invention relates to a media access control method in a wireless local area network (WLAN), and more particularly, to a WLAN media access control method for improving quality of service (QoS) of a voice over Internet protocol (VoIP) system using a WLAN.

2. Discussion of Related Art

In general, a wireless local area network (WLAN) operates within a range of 100 meters at a bit rate of 10 to 100 Mbps. When made up of a single cell, the WLAN can be appropriately used for a single-story office or a store.

In addition, a WLAN terminal is connected to another terminal and an access point (AP) in a network through a radio frequency (RF) link using a wireless network interface card (NIC). Here, the AP allows the WLAN terminal to access a wired network through a backbone network.

Approximately twenty five terminals can be connected in the single cell. A multiple cell can be made up using a plurality of APs connected to the wired network, and a WLAN environment can be constructed over an entire building using the multiple-cell.

The Institute for Electrical and Electronic Engineers (IEEE) has developed a standard defining a protocol for data frame transmission between a WLAN terminal and an AP. As a result, a standard for WLAN medium access and physical layer was developed (IEEE Std. 802.11, IEEE Standard for Wireless LAN Medium Access Control (MAC) and Physical Layer (PHY), 1999).

IEEE 802.11 WLAN standard specifies two main components of WLAN: a mobile terminal and a stationary AP. In the IEEE 802.11 WLAN standard, the terminal and AP for a single cell are defined as a basic service set (BSS), and the terminals and APs for a multiple cell are defined as an extended service set (ESS).

In addition, in the IEEE 802.11 WLAN, each terminal and an AP embody a MAC layer serving to exchange MAC frames. The MAC frames are used as a medium for control, management, and data transmission between the wireless terminal and the AP.

The standard defines two different wireless media access modes for the MAC layer. Among them, one is a distributed coordination function (DCF), and the other is a point coordination function (PCF).

According to the DCF, all stations can participate in contention for frame transmission. A basic access mode of IEEE 802.11 MAC is a carrier sense multiple access with collision avoidance (CSMA/CA) mode.

In the CSMA mode, a station intended to transmit data through a WLAN wireless medium detects the medium in order to check whether or not data is being transmitted from another station. When the medium is not occupied, the data transmission is possible. Otherwise, the data transmission is delayed until the ongoing data transmission is completed.

When the data transmission is enabled at the station immediately after the data transmission through the WLAN medium is completed, a plurality of stations can attempt to transmit the data. Hence, a probability of data collision increases. In order to solve this problem, a pause duration is given for a predetermined time after another data transmission is completed, binary random backoff for obtaining a transmission opportunity is performed to determine the size of a contention window (CW). The transmission opportunity is given to the station that has determined the minimum CW size. Such a process is a collision avoidance (CA) function.

Further, in the PCF, a point coordinator (PC) controls the data transmission of the WLAN terminal. In other words, the PC serves as a polling master, and performs polling on all PCF pollable terminals in order to determine the terminal capable of transmitting the data. Meanwhile, the PC may be located in the AP. In this case, in the PCF, the terminal may be polled or not.

When a pollable terminal receives a poll from the PC, only one MAC protocol data unit (MPDU) can transmit the data. When additional transmission is desired, the terminal should be on standby until the poll is received again. When specific data transmission is abnormally completed, the terminal cannot perform retransmission until the poll is received from the PC. Thus, the PCF provides a contention free mechanism (CFM) to give the terminal an opportunity to normally transmit the data.

Therefore, Enhanced-DCF complying with IEEE 802.11e standard is intended to improve QoS by adjusting the CW. More specifically, a lot of stations contend for network access during the CW duration. In order to avoid collision, first, a MAC protocol requires each station to be on standby for the CW duration selected by the binary random backoff.

In this manner, due to the CW duration selected by the binary random backoff, a probability of collision between the stations decreases.

Here, the EDCF makes use of the CW to give a high priority to a specific station. More specifically, the EDCF gives the high priority to the specific station by providing the specific station with a short CW duration. Consequently, in most cases, the terminal having the high priority transmits the data earlier than a terminal having a low priority.

Also, QoS is a means for measuring the quality of a service for users. Here, main criterions for measuring the QoS are message loss, message delay, network availability, and so forth.

The transmission of time-sensitive (such as audio or video) data application traffic on a packet network requests requirements meeting delay, delay jitter, and error rates.

Considering the above-mentioned wireless media access modes (DCF, PCF and EDCF) from the viewpoint of the QoS, the DCF mode performs the binary random backoff prior to frame transmission, so that a frame delay occurs.

The EDCF mode, which makes complementary to the DCF mode, allocates a priority to an audio frame by providing the audio frame with the CW duration shorter than that of a data frame, but still performs the backoff, so that the frame delay occurs.

Finally, the PCF mode allows the WLAN terminal to transmit a frame only by the polling in a contention free period (CFP), so that the frame delay occurs.

### SUMMARY OF THE INVENTION

It is an objective of the present invention to provide a method for reducing a transmission delay on the basis of non-contention without performing backoff and polling when transmitting an audio frame of a radio frequency (RF) link section in a voice over Internet protocol (VoIP) system having a wireless local area network (WLAN) function.

An aspect of the present invention provides a periodic media reservation method for quality of service (QoS) data having a periodic transmission characteristic in a WLAN. The periodic media reservation method comprises the steps of: (a) obtaining audio information through a WLAN terminal; (b) performing one of setting, change and removal of a reservation number (RN) according to an RN setting process between the WLAN terminal and an access point (AP); (c) transmitting an audio QoS frame including reservation information obtained by step (b) at every interval when an audio frame is generated in an RF link section; and (d) setting a reservation time on the basis of a reservation interval included in the received audio QoS frame.

Step (a) may comprise the step of receiving a generation interval and a playback section of the audio frame from an upper layer of WLAN media access control (MAC).

The setting of the RN in step (b) may comprise the steps of: requesting, by the mobile terminal (MT), the AP to set the RN using an Association Request frame; checking, by the AP, a reservation list to assign the RN; and transmitting, by the AP, an Association Response frame, and receiving, by the MT, the assigned RN.

The Association Request frame may include a generation interval and a playback interval, which are audio characteristic information.

The AP may assign the RN so as to prevent reservation repetition using the reservation interval and a transmission duration registered with the reservation list.

The changing of the RN in step (b) may comprise the steps of: requesting, by MT, the AP to change the RN using a Re-association Request frame; checking, by the AP, a reservation list to assign a new RN; and transmitting, by the AP, a Re-association Response frame, and receiving, by the MT, the assigned new RN.

The Re-association Request frame may comprise the RN or the audio information or both.

The removing of the RN in step (b) may comprise the steps of: requesting, by the MT, the AP to remove the RN using a Re-association Request frame; removing, by the AP, the RN from a reservation list; and transmitting, by the AP, a Re-association Response frame and checking, by the MT, the removed RN.

The Re-association Response frame may comprise the RN having a value of 0.

Step (c) may comprise the step of subtracting a reservation interval of a first frame by a time delayed through backoff.

Step (c) may comprise the step of giving up, by the MT transmitting a frame not including the reservation information, transmission when a remained transmission time is less than a desired transmission time of the frame to be transmitted by the MT.

Step (c) may comprise the step of transmitting, by the MT transmitting a frame not including the reservation information, the frame according to a distributed coordination function (DCF) when a remained transmission time is 0.

Step (c) may comprise the step of transmitting, by the MT transmitting frames including the reservation information, a final frame with the reservation time set to 0.

Step (d) may comprise the step of setting, by the MT having received the frame including the reservation information, the reservation time.

### BRIEF DESCRIPTION OF THE DRAWINGS

The above and other features and advantages of the present invention will become more apparent to those of ordinary skill in the art by describing in detail preferred exemplary embodiments thereof with reference to the attached drawings in which:

FIG. 1 is a block diagram of a wireless local area network (WLAN) system performing a quality of service (QoS) function on an audio frame in a radio frequency (RF) link section, according to the present invention;

FIGS. 2A to 2C illustrate reservation frame exchange processes for reservation number management, according to the present invention;

FIG. 3 illustrates formats of frames used in a reservation frame exchange process, according to the present invention;

FIG. 4 illustrates a method for reserving an RF link based on a generation interval of an audio frame, according to the present invention; and

FIG. 5 illustrates a format of a frame used in an audio frame exchange process, according to the present invention.

### DETAILED DESCRIPTION OF EXEMPLARY EMBODIMENTS

Hereinafter, exemplary embodiments of the present invention will be described in detail. However, the present invention is not limited to the exemplary embodiments disclosed below and can be implemented in various forms. Therefore, the present exemplary embodiments are provided for complete disclosure of the present invention and to fully inform the scope of the present invention to those of ordinary skill in the art.

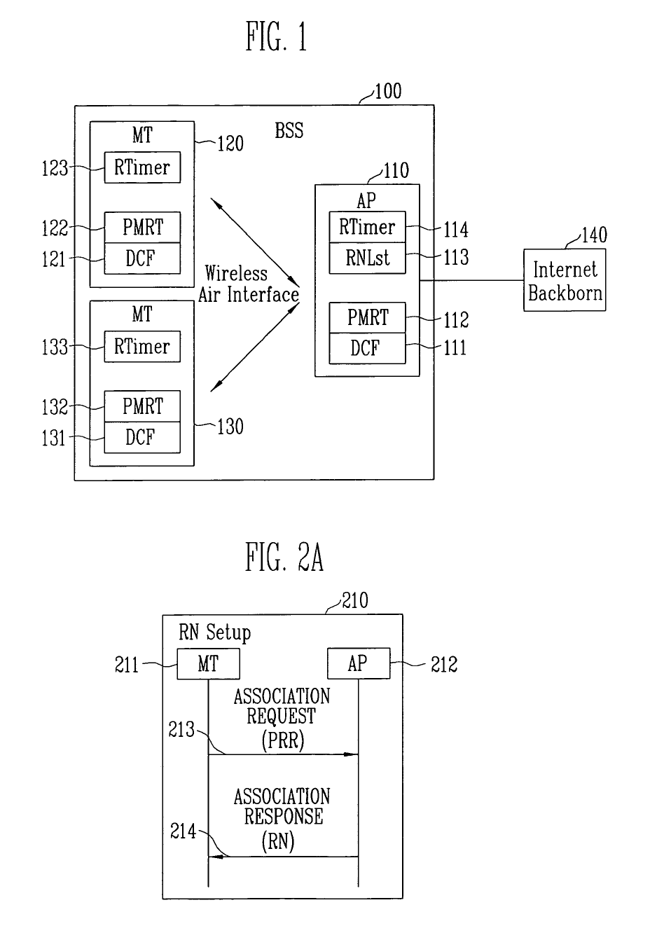

FIG. 1 is a block diagram of a wireless local area network (WLAN) system performing a quality of service (QoS) function on an audio frame in a radio frequency (RF) link section, according to the present invention.

Referring to FIG. 1, the WLAN system comprises mobile terminals (MT) 120 and 130, and an access point (AP) 110.

Here, the MTs 120 and 130 make up a basic service set (BSS) 100 through RF links together with the AP 110, and are connected to a WLAN. The AP 110 is connected to an Internet backbone (IB) 140.

Information transmission is possible in an up-stream direction from the MTs 120 and 130 to the IB 140 via the AP 110, and in a down-stream direction from the IB 140 to the MTs 120 and 130 via the AP 110.

Here, the MTs 120 and 130 and the AP 110 use two media access management modes: distributed coordination functions (DCFs) 121, 131 and 111 complying with the Institute for Electrical and Electronic Engineers (IEEE) 802.11 standard developed in 1999, and periodic media reservation timers (PMRTs) 122, 132 and 112 according to the present invention.

The MTs 120 and 130 of the BSS 100 are mounted with audio codecs, which have the identical frame generation interval.

Here, the MTs 120 and 130 have reservation timers (RTimers) 123 and 133, and manage information on the generation interval of a reservation frame. The AP 110 has an RTimer 114 and a reservation number list (RNList) 113, and manages reservation states of the MTs connected thereto.

Further, the MT 120, which transmits an audio frame, exchanges frames including QoS information with the AP 110 before transmitting the audio QoS frame. Then, the MT 120 is assigned a reservation number (RN) for transmitting the audio QoS frame, and transmits the frame. In contrast, the MT 130, which does not transmit the audio frame, activates the RTimer 133 when receiving the audio QoS frame.

The AP 110 manages the RNList 113 alone, and is not involved in the audio QoS frame exchange and reservation processes.

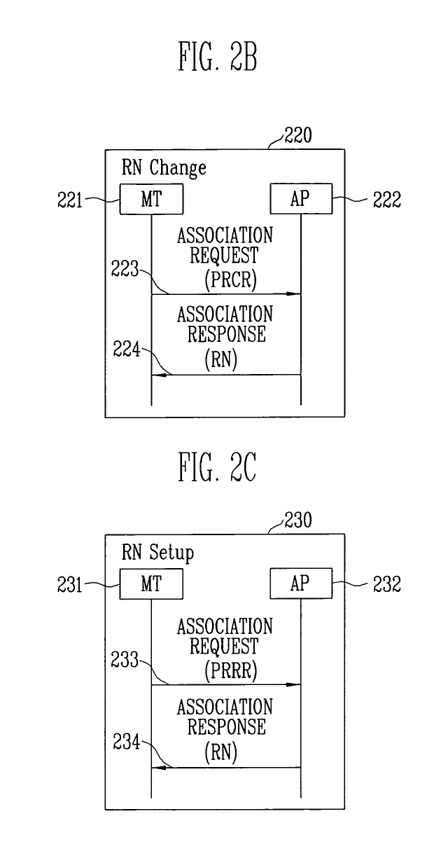

Methods for audio QoS frame transmission and its reservation state management will be described below in further detail with reference to FIGS. 2, 4, 5 and 6.

FIGS. 2A to 2C illustrate reservation frame exchange processes for RN management according to the present invention. More specifically, FIG. 2A illustrates a frame exchange process for RN assignment in an RN management method, FIG. 2B illustrates a frame exchange process for RN change in an RN management method, and FIG. 2C illustrates a frame exchange process for RN removal in an RN management method.

First, the frame exchange process for RN assignment 210 will be described with reference to FIG. 2A.

When there is an audio QoS frame to be transmitted, an MT 211 encapsulates a Periodic Reservation Request (PRR) field 213 into an Association Request frame, and transmits the Association Request frame to an AP 212. The AP 212 receiving the frame assigns a proper RN with reference to its own RNList 113, and then encapsulates the assigned RN 214 into an Association Response frame and transmits the Association Response frame to the MT 211.

Next, the frame exchange process for RN change 220 will be described with reference to FIG. 2B.

An MT 221, which needs to be assigned a new RN due to RN change or audio characteristic change, encapsulates a Periodic Reservation Change Request (PRCR) field 223 into a Re-association Request frame, and transmits the Re-association Request frame to an AP 222. The AP receiving the frame assigns a new RN with reference to its own RNList 113, and then encapsulates the RN 224 into a Re-association Response frame and transmits the Re-association Response frame to the MT 211.

Next, the frame exchange process for RN removal 230 will be described with reference to FIG. 2C.

When there is an audio frame to be transmitted, an MT 231 encapsulates a Periodic Reservation Remove Request (PRRR) field 233 into a Re-association Request frame, and transmits the Re-association Request frame to an AP 232. The AP 232 receiving the frame removes a corresponding RN with reference to its own RNList 113, and then sets an RN field 234 of a Re-association Response frame to 0 (null) and transmits the Re-association Response frame 234.

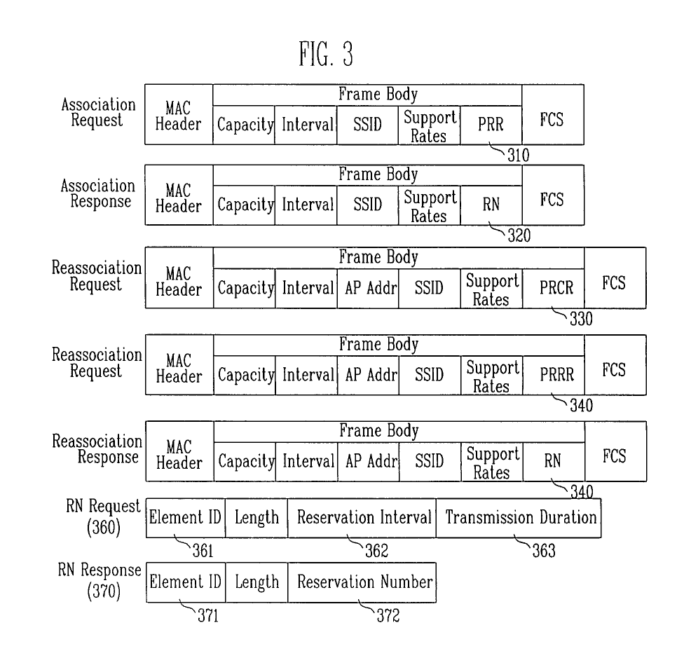

FIG. 3 illustrates formats of frames used in the reservation frame exchange processes, according to the present invention.

Referring to FIG. 3, the AP and MT make use of Association and Re-association frames according to the IEEE 802.11 standard in order to set a RN value, and add a PRR field 310, an RN field 320, a PRCR field 330, and a PRRR field 340 in order to set up an RN.

In order to be assigned the RN, the MT encapsulates the PRR field 310 into an Association Request frame and transmits the Association Request frame. The PRR field has a format of an RN Request field 360.

Here, an Element identifier (ID) 361 is set to 32, and the RN Request field 360 includes a Reservation Interval field 362 denoting a transmission interval of the audio frame, and a Transmission Duration field 363 denoting a time required to transmit a single audio frame.

Then, the AP requested to assign the RN encapsulate the RN field into the Association Response frame, and transmits the Association Response frame. The RN field has the format of an RN Response field 370. Here, an Element ID field 371 is set to 33, and the assigned RN is denoted in a Reservation Number field 372. However, in the case of a failure in assignment, the RN has a value of 0 (null).

Meanwhile, when the RN is changed, or when a reservation interval or a transmission time is changed, the MT encapsulates the PRCR field 330 into a Re-association Request frame and transmits the Re-association Request frame. The PRCR field has a combination format of the RN Request field 360 and the RN Response field 370.

First, when only the RN is to be changed, the Element ID field 371 and the Reservation Number field 372 are set to 34 and the previously assigned RN value respectively, by using the format of the RN Response field 370, and then transmitted.

Next, when the reservation interval and the transmission time are to be changed according to characteristic change of the audio frame, both the RN Response field 370 and the RN Request field 360 are encapsulated. Here, the RN Response field 370 is encapsulated prior to the RN Request field 360.

More specifically, in the RN Response field 370, the Element ID field 371 and the Reservation Number field 372 are set to 35 and the previously assigned RN value, respectively. In the RN Request field 360, the Element ID 361 is set to 32, and the changed Reservation Interval field 362 and the changed Transmission Duration field 363 are set. Then, the encapsulated frames are transmitted.

Then, the AP receiving an RN change request encapsulates an RN field into the Re-association Response frame, and transmits the Re-association Response frame. The RN field has the format of the RN Response field 370. Here, the Element ID field 371 is set to 33, and an assigned RN is denoted in the Reservation Number field 372. However, in the case of a failure in assignment, the RN has a value of 0.

Meanwhile, in order to remove the assigned RN, the MT encapsulates the PRRR field 340 into the Re-association Request frame, and transmits the Re-association Request frame. The PRRR field has a combination format of the RN Response field 370. At this time, the RN Response field 370 has the element ID field 371 and the Reservation Number field 372 set to 36 and the previously assigned RN value, respectively, and then transmitted.

The AP receiving an RN removal request encapsulates an RN field into the Re-association Response frame, and transmits the Re-association Response frame. The RN field has the format of the RN Response field 370. Here, the Element ID field 371 is set to 33, and the removed RN is denoted in the Reservation Number field 372. However, in the case of a failure in removal, the RN has a value of 0.

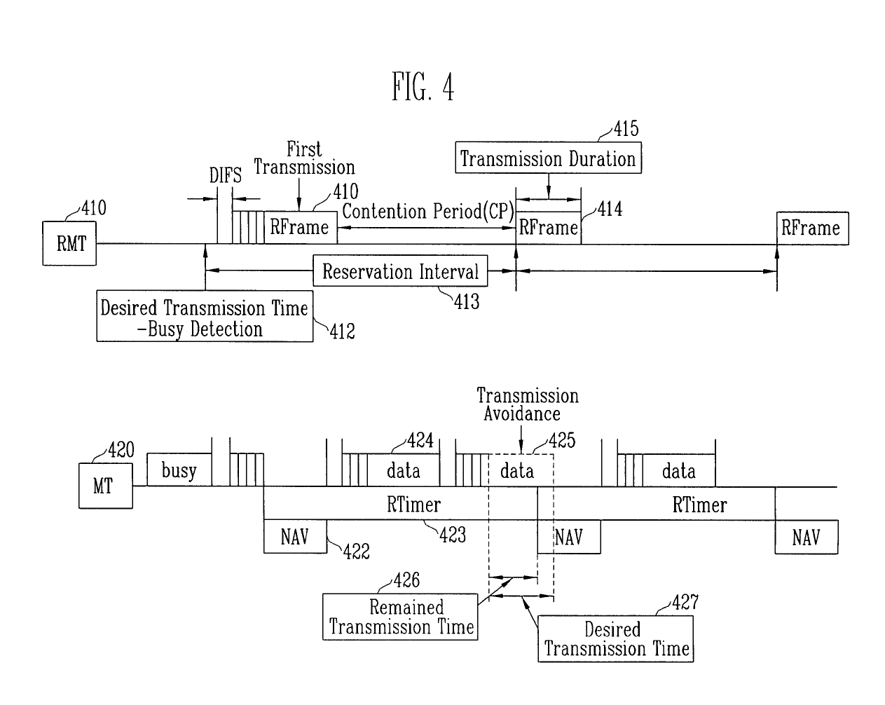

FIG. 4 illustrates a method for reserving an RF link based on a generation interval of an audio frame according to the present invention.

Referring to FIG. 4, a reserved MT (RMT) 410 transmitting audio QoS frames transmits a first audio QoS frame according to a general DCF transmission mode in which it is checked whether or not a wireless medium is used at a point of time 412 when the first audio QoS frame is desired to be transmitted, and then the first audio QoS frame is transmitted.

A second point of time for transmission starts when a Reservation Interval 413 reserved in an AP has lapsed from the point of time when the first audio QoS frame is desired to be transmitted (i.e. when audio data is generated). Therefore, the Reservation Interval 413 to be set for the header of the first audio frame has a value of the Reservation Interval reserved in the AP.

Here, when a transmission delay is caused by backoff during the first audio QoS frame transmission using the DCF, the set value of the Reservation Interval 413 has no less than a difference of the delayed time.

The other audio QoS frames starting from a second audio QoS frame have the Reservation Interval 413 set to the same value as the Reservation Interval reserved in the AP, and can be immediately transmitted without a backoff process.

When the final audio QoS frame is transmitted, the value of the Reservation Interval 413 is set to 0.

When a general MT 420 that does not transmit the audio QoS frame receives the audio QoS frame, it sets the value of a Network Allocation Vector (NAV) 422 as in the DCF and waits for the next transmission. And, the MT 420 activates an RTimer 423 with reference to the value of a Reservation Interval 413 included in a header.

When the NAV 422 is terminated, the MT 420 starts transmitting desired data according to the DCF (denoted by reference number 424).

When a Desired Transmission Time 427 required for next data transmission is more than a Remained Transmission Time 426, the MT 420 gives up transmission.

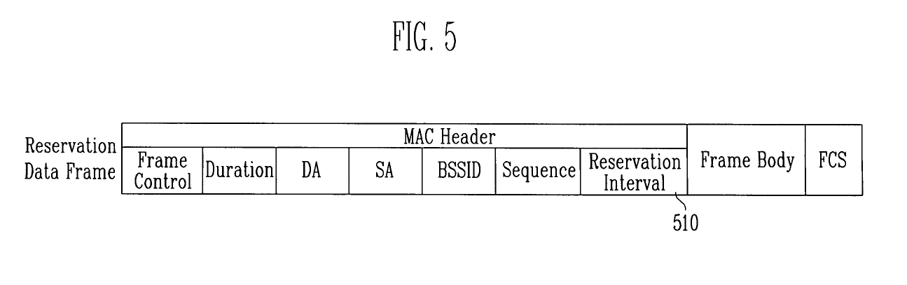

FIG. 5 illustrates a format of a frame used in an audio frame exchange process according to the present invention.

Referring to FIG. 5, the frame additionally has a Reservation Interval field 510 denoting a reservation interval in a data frame format of the IEEE 802.11 standard. The Reservation Interval field 510 denotes a remaining time until the next reservation frame is transmitted.

As described above, the present invention makes use of the RF link based on the PMRT scheme. According to the PMRT scheme, a terminal requested to transmit an audio frame informs an AP of both a reservation interval and a section, and is assigned an RN, sets the Reservation Interval field in a frame header at a point of time when the audio frame needs to be transmitted, and transmits the audio frame. The audio frame including such a Reservation Interval field is called the “audio QoS frame.”

When receiving such an audio QoS frame, all wireless terminals of the same BSS set an RTimer according to a value of the Reservation Interval field, and avoid transmission at a reserved time according to the RTimer.

As described above, the periodic media reservation method for the QoS data having the periodic transmission characteristic in the WLAN according to the present invention can transmit the audio frame without interference at a determined point of time. Therefore, it is possible to improve the QoS in the wireless transmission section by reducing the frame delay and jitter.

In addition, the periodic media reservation method reduces the transmission delay and jitter of the audio frame of the RF link section in the VoIP system having the WLAN function, so that it can improve the QoS of the RF link section.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A periodic media reservation method for quality of service (QoS) data having a periodic transmission characteristic in a wireless local area network (WLAN), comprising the steps of:
(a) obtaining audio information through at least one WLAN terminal;
(b) performing one of setting, change and removal of a reservation number (RN) through an RN setting process between the WLAN terminal and an access point (AP);
(c) transmitting an audio QoS frame including reservation information obtained by step (b) at every interval when an audio frame is generated in a radio frequency (RF) link section; and
(d) setting up a reservation time on the basis of the reservation information included in the received audio QoS frame.

2. The periodic media reservation method according to claim 1, wherein step (a) comprises the step of receiving a generation interval and a playback section of the audio frame from an upper layer of WLAN media access control (MAC).

3. The periodic media reservation method according to claim 1, wherein the setting of the RN in step (b) comprises the steps of:
requesting, by the mobile terminal (MT), the AP to set the RN using an Association Request frame;
checking, by the AP, a reservation list to assign the RN; and
transmitting, by the AP, an Association Response frame, and receiving, by the MT, the assigned RN.

4. The periodic media reservation method according to claim 3, wherein the Association Request frame comprises the generation interval and a playback interval, which are audio characteristic information.

5. The periodic media reservation method according to claim 3, wherein the AP assigns the RN so as to prevent reservation repetition using a reservation interval and a transmission duration that are registered with the reservation list.

6. The periodic media reservation method according to claim 3, wherein the Association Response frame comprises the assigned RN.

7. The periodic media reservation method according to claim 1, wherein the changing of the RN in step (b) comprises the steps of:
requesting, by the mobile terminal (MT), the AP to change the RN using a Re-association Request frame;
checking, by the AP, a reservation list to assign a new RN; and
transmitting, by the AP, a Re-association Response frame, and receiving, by the MT, the new RN.

8. The periodic media reservation method according to claim 7, wherein the Re-association Request frame comprises the RN or the audio information or both.

9. The periodic media reservation method according to claim 1, wherein the removing of the RN in step (b) comprises the steps of:
requesting, by the mobile terminal (MT), the AP to remove the RN using a Re-association Request frame;
removing, by the AP, the RN from a reservation list; and
transmitting, by the AP, a Re-association Response frame, and checking, by the MT, the removed RN.

10. The periodic media reservation method according to claim 9, wherein the Re-association Response frame comprises the RN having a value of 0.

11. The periodic media reservation method according to claim 1, wherein step (c) comprises the step of subtracting a reservation interval of a first frame by a time delayed through backoff.

12. The periodic media reservation method according to claim 1, wherein step (c) comprises the step of giving up, by the mobile terminal (MT) transmitting a frame including no reservation information, transmission when a remained transmission time is less than a desired transmission time of the frame to be transmitted by the MT.

13. The periodic media reservation method according to claim 1, wherein step (c) comprises the step of transmitting, by the mobile terminal (MT) transmitting a frame including no reservation information, the frame according to a distributed coordination function (DCF) when a remained transmission time is 0.

14. The periodic media reservation method according to claim 1, wherein step (c) comprises the step of transmitting, by mobile terminal (MT) transmitting frames including the reservation information, a final frame with the reservation time set to 0.

15. The periodic media reservation method according to claim 1, wherein step (d) comprises the step of setting, by the mobile terminal (MT) receiving the frame including the reservation information, the reservation time.
